(19) United States
(12) Patent Application Publication
(10) Pub. No.: US 2025/0360474 A1
(43) Pub. Date: Nov. 27, 2025

(54) Freezable Agitator for Mixing and Chilling Beverages

(71) Applicant: Logan Kelly, Gilbert, AZ (US)

(72) Inventor: Logan Kelly, Gilbert, AZ (US)

(21) Appl. No.: 19/216,065

(22) Filed: May 22, 2025

Related U.S. Application Data
(60) Provisional application No. 63/651,158, filed on May 23, 2024.

(51) Int. Cl. B01F 33/25; A47J 43/27; B01F 35/90; B01F 35/95; B01F 101/14

(52) U.S. Cl. CPC B01F 33/251; A47J 43/27; B01F 35/95; B01F 2035/98; B01F 2101/14

(57) ABSTRACT

The invention relates to a freezable agitator for mixing and chilling beverages without requiring external cooling sources. Traditional mixing devices may assist with mixing but do not address the challenge of maintaining a cold beverage temperature without requiring external cooling sources. This challenge is especially evident when users are on the go, where refrigeration is typically unavailable. Users often add ice as a workaround, which can dilute the beverage and diminish flavor and consistency. The agitator comprises a sealed hollow body partially filled with a freezable liquid and formed with two continuous spiral ridges. The ridges promote mixing when the agitator is shaken inside a beverage container, while the internal freezable medium chills the beverage over time. The design eliminates the need for ice or external cooling sources, providing a reusable solution for maintaining cold, well-mixed drinks throughout the day.

### CROSS-REFERENCE TO RELATED APPLICATIONS

This application claims the benefit of U.S. Provisional Patent Application No. 63/651,158, filed May 23, 2024, the contents of which are incorporated by reference in their entirety.

### BACKGROUND OF THE INVENTION

### Field of the Invention

The present invention relates generally to a device to both mix and cool beverages without requiring the addition of ice or other external cooling sources.

### Description of Related Art

Traditional beverage containers and shaker bottles often use separate devices for mixing (such as whisk balls, screens, or other blending mechanisms). While these designs may assist with mixing, they do not address the challenge of maintaining a cold beverage temperature without requiring external cooling sources. This challenge is especially evident when users are on the go, where refrigeration is typically unavailable. Users frequently resort to adding ice, which can dilute the beverage and diminish flavor and consistency. Other common workarounds include using a protein storage container to mix with water when ready to drink. This method can be messy, and the available water is often not cold. Some users also opt to purchase expensive pre-made shakes. Currently, no known beverage agitators provide both effective mixing and sustained cooling in a single, reusable device that operates without added ice or refrigeration.

### SUMMARY OF THE INVENTION

The invention disclosed herein is a freezable agitator designed to combine effective beverage mixing with prolonged cooling capabilities. The agitator features a sealed body partially filled with a freezable liquid such as distilled water. Its exterior is formed to enhance mixing when shaken, while the internal contents act as a thermal mass that chills the beverage temperature for a period of time. The design eliminates the need for ice or other external cooling sources, preventing dilution while preserving beverage flavor and consistency. The agitator is reusable and adaptable for use in a variety of beverage containers, providing a convenient solution for maintaining cold, well-mixed drinks, particularly when refrigeration is unavailable or when users are on the go.

### BRIEF DESCRIPTION OF THE DRAWINGS

The following detailed description of preferred embodiments of the invention will be better understood when read in conjunction with the accompanying drawings. These drawings illustrate embodiments that are presently preferred, but the invention is not limited to the precise arrangements and instrumentalities shown.

FIG. 1: Front view of the freezable agitator, showing the sealed hollow body, widened central region, tapered ends, and spiral ridges.

FIG. 2: Cross-sectional side view of the freezable agitator taken along line A-A, illustrating the internal fill and construction, including the freezable medium within the hollow body, and showing a reference view with the section cut line indicated.

FIG. 3: Top view highlighting the arrangement of the spiral ridges and the contoured profile of the agitator.

FIG. 4: Side view of the freezable agitator showing the contoured profile, spiral ridges, and tapered ends.

FIG. 5: Use case diagram showing the agitator inside a shaker bottle while being shaken, illustrating one preferred embodiment. In this scenario, the agitator is actively mixing the beverage as opposed to floating passively when at rest. The invention is adaptable to a variety of beverage containers.

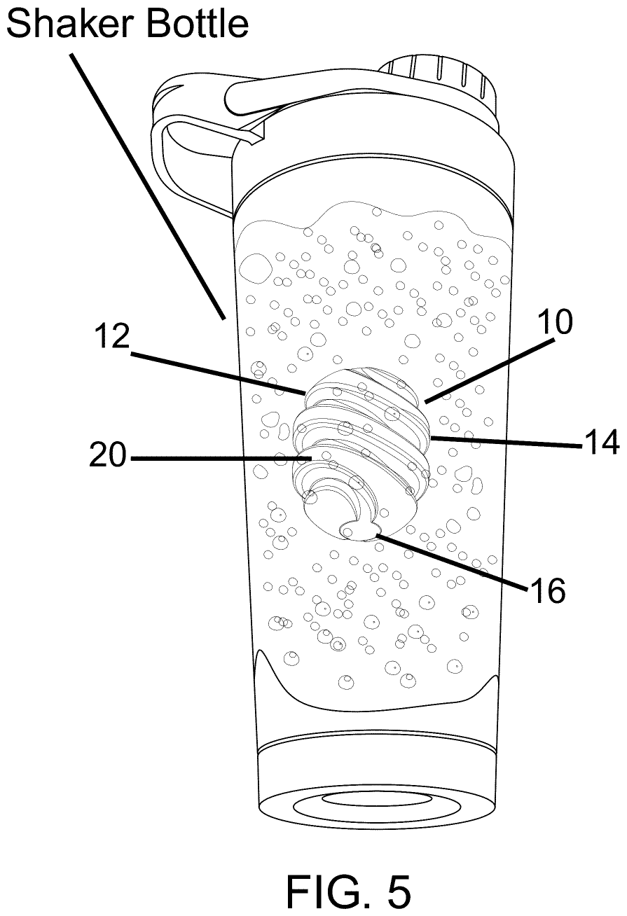

### DETAILED DESCRIPTION OF THE PREFERRED EMBODIMENT

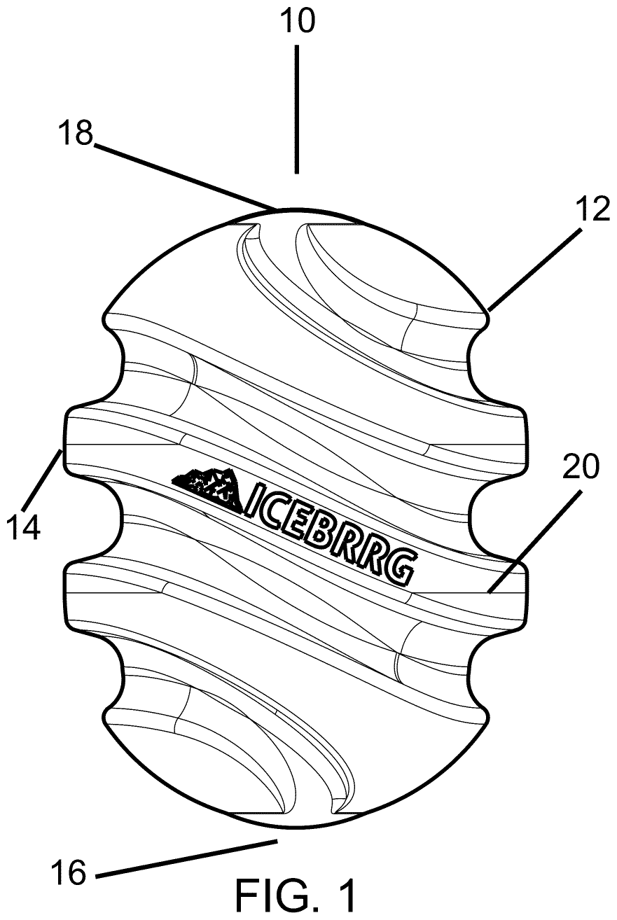

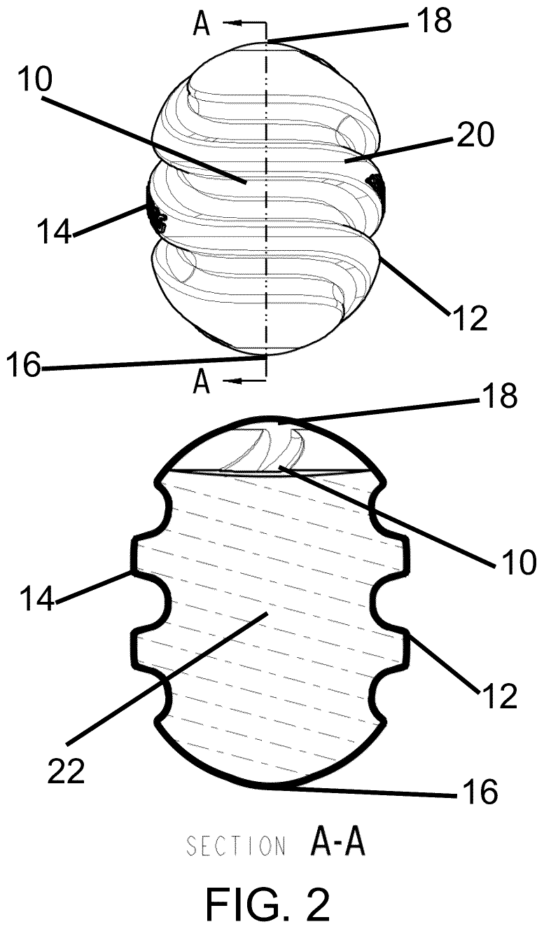

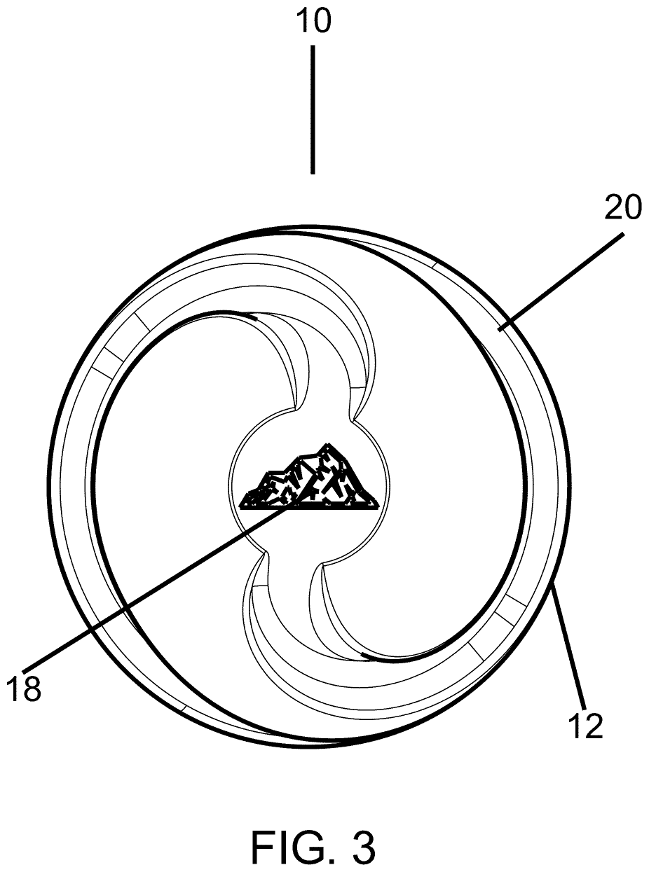

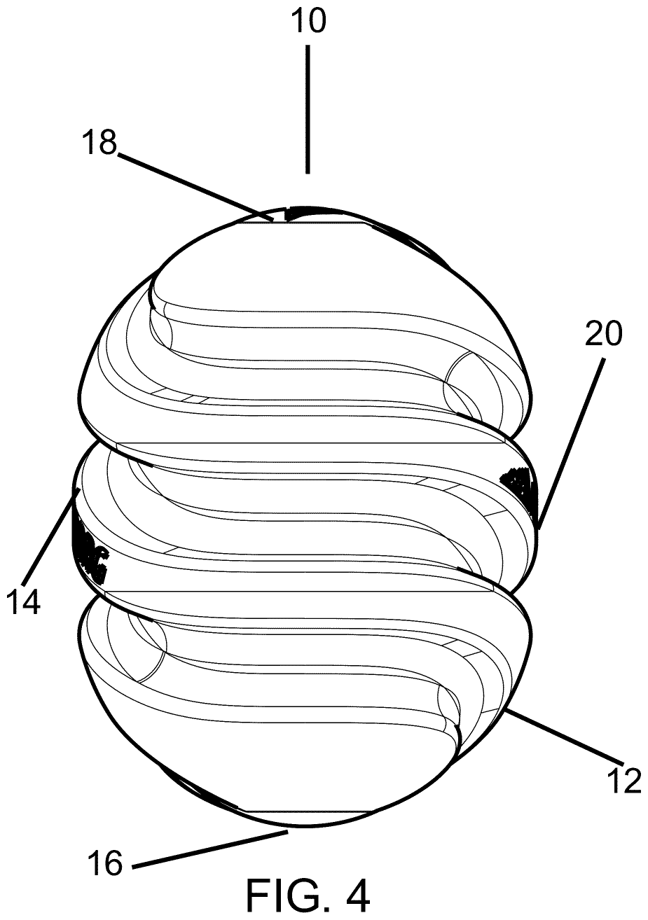

Referring now to FIGS. 1 through 4, the freezable agitator (10) includes a sealed hollow body (12) having a widened central region (14) and tapered ends (16, 18). The agitator includes two continuous spiral ridges (20) that begin adjacent to each other on one end, wrap around the hollow body (12) creating grooves between them, and extend to the opposite tapered end (16, 18) to facilitate mixing within a liquid medium.

The body (12) is formed using blow-molded high-density polyethylene (HDPE), resulting in a durable and food-safe housing. During manufacture, the body is initially hollow and then filled approximately ninety percent (90%) with distilled water (22) before being hermetically sealed via a plastic weld at the base of one end.

The agitator (10) is dimensioned to fit within standard shaker bottles commonly used for protein shakes, pre-workout supplements, and other powdered beverages, while also being adaptable for use in a variety of beverage containers beyond shaker bottles. In operation, the agitator is first placed in a freezer until sufficiently frozen. Once frozen, it is inserted into a beverage container containing a liquid (e.g., water, milk, dairy alternative, etc.) and optionally a powdered supplement. Shaking the bottle with the frozen agitator allows for both efficient blending and active cooling over an extended period.

In a preferred use case, the shaker bottle is double-wall vacuum insulated to further extend the beverage's cold retention. Testing has shown that when used in plastic shaker bottles, the agitator maintains the beverage below its initial temperature for at least two hours. When used in insulated stainless steel bottles, the cooling duration can extend up to twelve hours.

Surface texturing beyond the spiral ridges may be incorporated to further enhance mixing efficiency and prevent clumping. The design may also include antimicrobial surface treatments or impact-reducing features, such as cushioning materials (e.g., silicone or elastomeric pads) affixed to one or both ends of the agitator, or a separate cushioning insert designed to rest at the bottom of the container to prevent potential damage upon contact.

Alternative embodiments may utilize different freezable mediums, including phase change materials designed to maintain target temperature ranges longer than water. The agitator may be produced in multiple sizes to accommodate a variety of beverage containers.

Additionally, the agitator may include a coupling feature configured to allow attachment to the lid or interior surface of the beverage container, particularly in embodiments constructed from heavier materials such as stainless steel.

### INDUSTRIAL APPLICABILITY

The invention has broad applicability in the fitness, nutrition, food service, and beverage industries. It provides a convenient, reusable solution for individuals who consume a variety of beverages and value cold, well-mixed drinks throughout the day, especially in situations where refrigeration is unavailable or portability is essential. The agitator reduces reliance on external cooling sources and expensive pre-made beverages, offering convenience and helping users avoid the common problems of warm or watered-down drinks. Its versatility extends to protein shakes, meal replacements, smoothies, iced coffee, tea, cocktails, and more, making it suitable for a variety of beverage types, especially for individuals on the go.

1. A freezable agitator for use in a beverage container, comprising:
(a) a sealed hollow body partially filled with a freezable medium;
(b) an exterior surface configured to mix a beverage when the agitator is shaken within the container;
wherein the agitator is adapted to be frozen prior to use and functions to both mix and maintain a reduced temperature of the beverage without requiring added ice or external cooling agents.

2. The agitator of claim 1, wherein the sealed hollow body comprises a blow-molded plastic.

3. The agitator of claim 1, wherein the sealed hollow body is composed of a food-safe material selected from the group consisting of high-density polyethylene, polypropylene, stainless steel, or other suitable polymers or metals.

4. The agitator of claim 2, wherein the blow-molded plastic is high-density polyethylene (HDPE).

5. The agitator of claim 1, wherein the sealed hollow body is filled approximately ninety percent with distilled water as the freezable medium.

6. The agitator of claim 1, wherein the exterior surface includes at least one spiral ridge configured to enhance mixing efficiency during shaking.

7. The agitator of claim 6, wherein two continuous spiral ridges extend from one end of the hollow body, wrap around the exterior surface creating recessed grooves between them, and continue to the opposite end of the hollow body.

8. The agitator of claim 1, wherein the hollow body includes a contoured profile having tapered ends and a widened central region.

9. The agitator of claim 1, wherein the agitator is dimensioned to fit within a standard shaker bottle commonly used for mixing powdered nutritional supplements.

10. The agitator of claim 1, wherein the mixing includes combining a liquid with a powdered supplement.

11. The agitator of claim 1, wherein the agitator, after being sufficiently frozen, maintains a reduced beverage temperature for an extended period following removal from the freezer.

12. The agitator of claim 1, wherein the exterior surface further includes surface texturing configured to enhance mixing efficiency or prevent clumping.

13. The agitator of claim 1, wherein the freezable medium comprises a phase change material selected to maintain a target temperature range longer than water.

14. The agitator of claim 1, wherein the body is produced in multiple size variations to fit a range of beverage containers.

15. The agitator of claim 1, wherein at least a portion of the exterior surface includes an antimicrobial coating or treatment.

16. The agitator of claim 1, further comprising a cushioning material attached to at least one end of the body, or a cushioning insert configured to rest at the bottom of a beverage container; the cushioning material comprising silicone or a similar elastomeric substance configured to prevent damage or denting of the beverage container upon contact.

17. The agitator of claim 1, wherein the agitator includes a coupling feature configured to attach the agitator to a lid or interior surface of the beverage container.
